(19) United States
(12) Patent Application Publication
(10) Pub. No.: US 2012/0146518 A1
(43) Pub. Date: Jun. 14, 2012

(54) Predicative lighting control system

(76) Inventors: Mark Keating, N. Saint Petersburg, FL (US); Keith Graeber, Davis, CA (US); Michael Siminovitch, Davis, CA (US); Kosta Papamichael, Davis, CA (US)

(21) Appl. No.: 13/374,059

(22) Filed: Dec. 8, 2011

Related U.S. Application Data
(60) Provisional application No. 61/459,336, filed on Dec. 13, 2010.
(60) Provisional application No. 61/519,296, filed on May 20, 2011.

(51) Int. Cl. H05B 37/02

(52) U.S. Cl. 315/153

(57) ABSTRACT

A light management system is disclosed. The light management system includes networked control modules and computer devices that utilize object detection and geographical location information to predict a direction and/or determine speed of an object along a pathway. Based on the predicted direction and/or determined speed of the object along the pathway, the control modules turn on lighting in advance of the arrival of the object along the pathway. The light management system preferably also provides light usages data or operation data to the one or more remote computer devices.

### RELATED APPLICATION

This patent application claims priority under 35 U.S.C. 119 (e) of the U.S. Provisional Patent Application Ser. No. 61/459,336 filed Dec. 13, 2010, and titled “PREDICTIVE LIGHTING CONTROL SYSTEM” and the U.S. Provisional Patent Application Ser. No. 61/519,296 filed May 20, 2011, and titled “PREDICTIVE LIGHTING CONTROL SYSTEM”. The U.S. Provisional Patent Application Ser. No. 61/459,336 filed Dec. 13, 2010, and titled “PREDICTIVE LIGHTING CONTROL SYSTEM” and the U.S. Provisional Patent Application Ser. No. 61/519,296 filed May 20, 2011, and titled “PREDICTIVE LIGHTING CONTROL SYSTEM” are both hereby incorporated by reference.

### FIELD OF THE INVENTION

This invention relates to lighting control systems. More specifically, this invention relates to predictive lighting control systems for saving energy and promoting safety.

### BACKGROUND OF THE INVENTION

A number of different light management systems are known for controlling lighting both indoors and outdoors. One type of light management system utilizes motion detectors or occupancy sensors. In these systems, lights are turned off, turned on and/or are dimmed according to a detected levels of motion or occupancy within the area around the motion sensors or occupancy sensors.

In some more complex light management systems, the light output levels are reduce when no motion is detected and/or occupancy is not sensed, thus maintaining visibility while saving energy. The light output is then raised to a higher level only when motion is detected or occupancy is sensed. The light output levels generally remain at the higher level until no motion is detected or occupancy is not sensed for a pre-selected period of time, at which point the lamps in fixtures are reset back to their lower level. While these light management systems afford some energy savings they do not promote safety for pathway lighting nor do such light management system anticipate or predict lighting needs for a time in the future.

### SUMMARY OF THE INVENTION

The present invention is directed to a light management system, also referred to herein as a predictive lighting control system. The light management system of the present invention has applications for indoor lighting and outdoor lighting. In outdoor lighting, the light management system of the present invention is particularly well suited for street lighting, parking lot lighting, pathway lighting and lighting for recreational areas, such as parks and the like.

The light management system preferably provides a number of capabilities including, but not limited to, the ability to operate lighting according to programmed schedules and control profiles. The light management system includes control modules that are networked to one or more remote computer devices for two-way communication. The control modules are capable of providing light usages data or operation data to the one or more remote computer devices. For example, the control modules report power consumption and lighting failure reports to the one or more remote computer devices. The light management system of the present invention also preferably includes override features which allow lighting to be turned on manually or automatically in response to override commands from the one or more remote computer devices. The light management system also is capable of supporting override features at the control modules, which allow lighting to be turn on manually in an emergency and/or cause the control modules to initiate an emergency call to an emergency responder locations.

Control modules preferably include sensors for detecting the motion or occupancy within detection areas corresponding to the geographical locations of the control modules. The sensors are, for example, infrared sensors, ultrasonic sensors, optical sensors (camera) or any other suitable sensor or combinations of sensors that are capable of detecting motion or occupancy. The control modules further include control circuits for controlling one or more load circuits electrically coupled to the lighting. The control circuits are preferably electrically coupled to the load circuit through suitable wire leads and/or contacts. The control modules further include micro-processors which provide instructions to the control circuits. The micro-processors are programmed with executable code or software that instruct the control circuits to control the one or load circuits when the sensors detects motion and/or occupancy with the detection areas of the control modules. Also, the micro-processors instruct the control circuits to control the lighting when a detection area of a control module corresponds to the predicted direction of an object along the pathway.

In accordance with the embodiments of the invention, the control modules are also networked to each other through transducers. The transducers are preferably radio transducers. In operation, the control modules receive and transmit detection signals between each other when motion or occupancy is detected within their respective detection areas.

The control modules are also commissioned or programmed with geographical location information, also referred to as addresses or sequencing numbers. Alternatively, the control modules include a G.P.S. (Global Positions Systems) and, therefore, have geographical location information at all times. Using the geographical location information and the detection signals, indicating which other control modules have detected motion or occupancy, any given control module within the lighting management system is then capable of determining if it is in a predicted direction of an object along the pathway. When any given control module within the lighting management system determines that it is in a predicted direction of an object along the pathway, that control module then controls the lighting to provide light in advance of the arrival of the object. In further embedment of the invention, the lighting management system also determines a speed of the object along the pathway and controls lighting along the pathway a rate that corresponds to or exceeds the determined speed of the object.

### BRIEF DESCRIPTION OF THE DRAWINGS

FIG. 1 is a schematic representation of a control module, in accordance with the embodiments of the invention.

FIG. 2 shows a control module networked to a remote computer device, in accordance with the embodiments of the invention.

FIG. 3 shows a representation of a light management system with a number of control modules networked to each other and to computer devices, in accordance with the embodiments of the invention.

FIG. 4 shows graphical representation of light management system for providing pathway lighting, in accordance with the embodiments of the invention.

FIG. 5 shows a block-flow diagram outlining steps for managing lighting, in accordance with the method of the present invention.

### DETAILED DESCRIPTION OF THE INVENTION

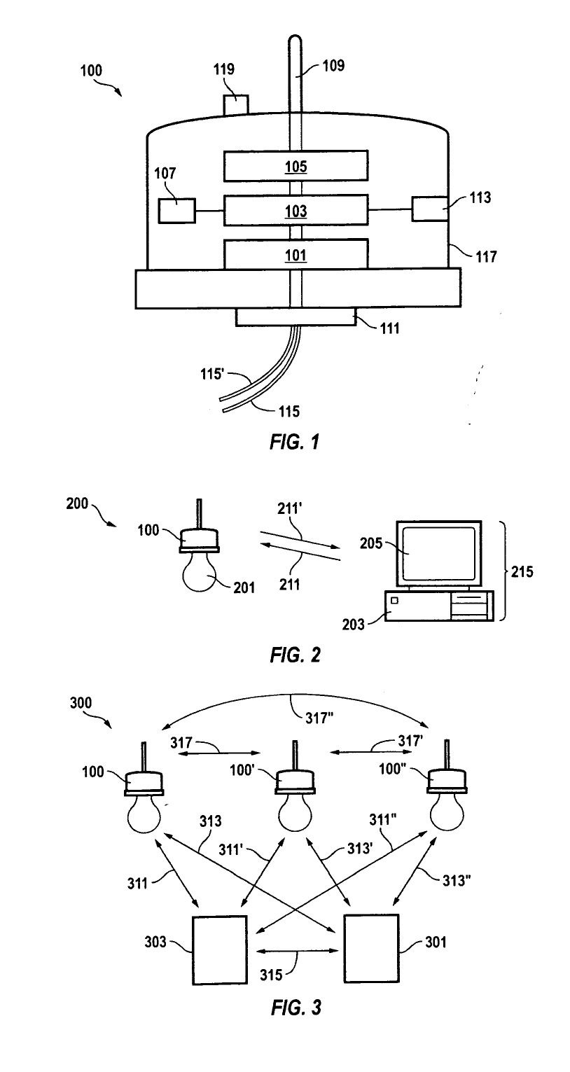

FIG. 1 is a schematic representation of a control module 100, in accordance with the embodiments of the invention. The control module 100 include a housing 117 for protecting internal components and a mounting mechanism 111. The mounting mechanism 111 is preferably configured to attached to lamp fixture, for example, a street light fixture. The control module 100 also includes a sensor 113 for detecting the motion or occupancy within a detection area of the control module 100. The sensor 113 is, for example, an infrared sensor, an ultrasonic sensor, an optical sensor (camera) or any other suitable sensor or combination of sensors. The control module 100 further includes a control circuit 100 for controlling a load circuit (not shown) that is electrically coupled to the lighting (not shown). The control circuit 101 is electrically coupled to the load circuit through, for example, the wire leads and/or contacts 115 and 115′.

The control module 100 further includes a micro-processor 103 which provides instructions to the control circuit 101 to control lights through the load circuit. For example, the micro-processor 103 is programmed with executable code or software that instructions the control circuit 101 to control the load circuits when the sensor 113 detects motion and/or occupancy with the detection area of the control module 100. Also, the micro processor 103 instructs the control circuit 101 to control the lighting when the detection area and/or geographical location of the control module 100 corresponds to a predicted direction of an object along the pathway.

The control module 100 also preferably includes and ambient light sensor 119 that signals the control circuit 101 to automatically turn on and off and brighten or dim lighting in response to the ambient lighting. The ambient light sensor 119 is a photo-cell or any other suitable light sensor. Further, the control module 100 includes a transducer 105 and antenna 109 for receiving detection signals from and transmitting detection signals to additional control modules within the light management system, such as described in detail below. The control module 100 further includes a memory unit for storing programs, light usage data, operation data, maintenance history and/or any other systems information.

Further details of the control module 100, including wiring diagrams, communication protocols and structural features are provided in the U.S. Provisional Patent Application Ser. No. 61/459,336, titled “PREDICTIVE LIGHTING CONTROL SYSTEM” and the U.S. Provisional Patent Application Ser. No. 61/519,296, titled “PREDICTIVE LIGHTING CONTROL SYSTEM” the contents of which are both incorporated by reference.

FIG. 2 shows a schematic representation of a control module 100 that is networked with a remote computer device 215. The control module 100 is configured to control lighting 201 that is electrically coupled to the control module 100 through a load circuit, such as described above and below. The remote computer device 215 is in two-way communication with the control module 100, as indicated by the arrows 211 and 211′. The remote computer device 215 includes, for example, a processor 203 and a display and/or user interface 205. The remote computer device 215 is a personal computer, a server, a cellular phone or any other suitable electronic device capable of supporting a network that provides two-way communication with the control module 100.

Preferably systems information is accessible and/or viewable from the remote computer device 215 and the remote computer device 215 is configured to program or commission the control module 100 with the geographical location information and/or executable code or software that allows the control module 100 to communicate with additional control modules within the light management system. The geographical location information and/or executable code or software allows the control module 100 to calculate a predicted direction and/or detected speed of an object along a pathway. The remote computer device 215 and the control module 100 are networked to provide the two-way communication through any suitable communication means including, but not limited to, internet, intranet, radio, ethernet or any combination thereof. Further, the network uses any suitable communication protocol. Preferably, the remote computer 215 and the control module 100 are networked to provide the two-way communication by a wireless network.

FIG. 3 shows a representation of a light management system 300 with a number of control modules 100, 100′ and 100″ networked to each other and to multiple computer devices 301 and 303. In accordance with the embodiments of the invention the control modules 100, 100′ and 100″ are networked to each other to provide two-way communication, as indicated by the arrows 317, 317′ and 317″ through radio transducers, such as described above. The radio transducers receive and transmit detection signals between the control modules 100, 100′ and 100″, when motion or occupancy is detected within detection areas of the control modules 100, 100′ and 100″ to determine if one or more of the other control modules is located in a predicated direction of the an object along a pathway of the lighting management system 300.

The computer devices 301 and 303 are, for example, a mobile computer device 301 that is networked through a server 303. The mobile computer device 301 and the server 303 are preferably in two-way communication, as indicated by the arrow 315 using any suitable network and communication protocol. In accordance with the embodiments of the invention, the control modules 100, 100′ and 100″ are networked the portable computer device 301, as indicated by the mobile 313, 313′ and 313″, and/or the server 303, as indicated by the arrows 311, 311′ and 311″ through a wireless communication protocol.

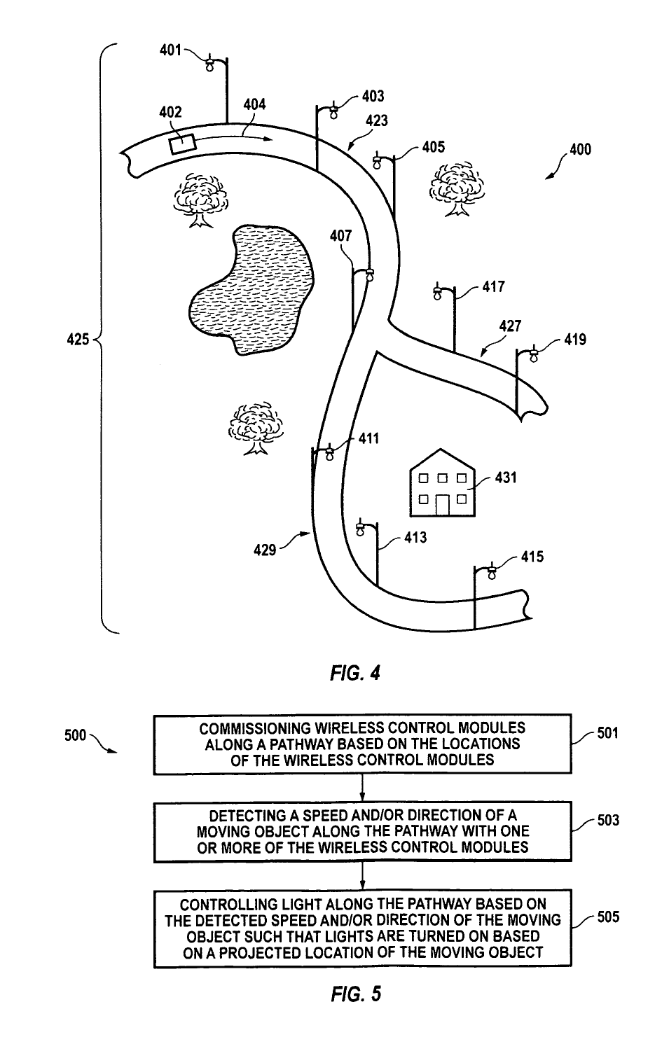

FIG. 4 shows graphical representation of light management system 400 of the present invention along a pathway 424. The light management system 400 includes number of light fixtures 401, 403, 405, 407, 411, 413, 415, 417 and 419. Each of the light fixtures 401, 403, 405, 407, 411, 413, 415, 417 and 419 are preferably equipped with a control module, such as the control module 100 (FIG. 1). The control modules are networked to each other and at least one remote computer device 215 (FIGS. 2) 301 and 303 (FIG. 3) at a remote location 431. The remote computer device helps to support the system capabilities described above. It will be clear to one skilled in the art that the light management system of the present invention is capable of having any number of light fixtures and with any number of geographical arrangements and that the pathway lighting shown in FIG. 4 is being used for illustrative purposes only.

In operation, an object 402 moves along a first portion 423 of the pathway 425 in a direction at a speed indicated by the arrow 404. As the object 402 passed the light fixture 401, the corresponding control module detects the object 402 and triggers a lamp of the light fixture 401 to be turned on or brightened. Then as the object 402 passed the light fixture 403, the corresponding control module detects the object 402 and triggers the lamp of the light fixture 403 to be turned on or brightened. After a preselected period of time the control module corresponding to the light fixture 401 turns off or dims the lamp of the light fixture 401. Based on the detection events of the control modules corresponding to the light fixtures 401 and 403, the light management system 400 determines that the object 402 is heading in a predicted direction and/or at detected speed down the first portion 423 of the pathway 425. Based on the predicted direction and/or the determined speed of the object 402, one or more of the control modules corresponding to light fixtures 401 and 403 sends detection signals to the control modules corresponding to the light fixtures 405 and 407. The control modules corresponding to the light fixtures 405 and 407 then turn on or brighten lamps corresponding the light fixtures 405 and 407 in advance of the arrival of the object.

While a predicted direction or a determined speed of the object is typically determined by the light management system 400 based on two or more detection events, the light management system 400 is capable of being configured to predict a direction and/or determine a speed of an object based on a single event. In this case, the light management system 400 is configured to self-correct the lighting, when the light management system 400 determines that the predicted direction and/or detected speed was incorrect based on future detection events of the light management system 400.

In multi-directional pathway lighting such as shown in FIG. 4, the light management system 400 determines if the object 402 is proceeding down a second portion 429 or a third portion 427 of the pathway 425. In this case, the light management system 400 initiates lamps of both lighting fixtures 411 and 417 to be turned on or brightened in advance of the objects arrival. Then when the control modules of the lamp fixture 411 or 417 determines which of the second portion 429 or a third portion 427 of the pathway 425 the object is actually traveling down, then the light management system 400 provides addition lighting by turning on or brightening lamps on selected light fixtures of 413 or 415 and 419 which correspond to the actual direction of the object and turns off or dims the lamps on the light fixtures of 413 or 415 and 419 which do not correspond to the actual direction of the object. By having control modules that are networked together and that continually monitor the movements and/or speeds of objects along the pathway, the light management system 400 is capable of adapting the pathway lighting to meet the needs or people or objects along the pathway in both a predictive and dynamic fashion and, thus, saving energy and promoting safety.

FIG. 5 shows a block-flow diagram 500 outlining steps for managing lighting along a pathway, in accordance with the method of the present invention. In the step 501, wireless control modules are commissioned with geographical location information along a pathway. As described previously the control modules are configured for controlling lighting along the pathway and are networked to each other through transducers for receiving and transmit detection signals between each other when motion or occupancy is detected within their respective detection areas. After the wireless control modules are commissioned with geographical location information along a pathway in the step 501, in the step 503 the control modules are used to detect a speed and/or predict a direction of the an object along the pathway. After the control modules detect the speed and/or the predict direction of the object along the pathway in the step 503, in the step 505 the control modules control the lighting in along the pathway in advance of the arrival of the object along the pathway based on the detected speed and/or predicted direction of the object.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A light management system comprising a control module for controlling lighting based on detected motion or occupancy within a detection area of the control module along a pathway and for controlling the lighting when the detection area of the control module corresponds to a predicted direction of an object along the pathway based on the detected motion or occupancy from additional control modules positioned along the pathway.

2. The light management system of claim 1, wherein the control module comprises:
a) a sensor for detecting the motion or occupancy within the detection area;
b) a control circuit for controlling a load circuit electrically coupled to the lighting;
c) a micro-processor with software configured to instruct the control circuit to control the load circuit when the detection area of the control module corresponds to the predicted direction; and
d) a transducer for receiving detection signals from the additional control modules corresponding to the detected motion or occupancy within detection areas of the additional control modules and for transmitting detection signals to the additional control modules corresponding to the detected motion or occupancy within the detection area of the control module.

3. The light management system of claim 1, wherein the control module further comprises a coupling mechanism for attaching to a street light.

4. The light management system of claim 1, wherein the control module further comprises an ambient light sensor configured to control the lighting based on a detected level of ambient light.

5. The light management system of claim 1, wherein the control module further comprises a memory unit for storing light usage data.

6. The light management system of claim 1, wherein the control module is configured to be commissioned with a location address and wherein the control module broadcasts the location address and an operating status to remote computer device.

7. A light management system comprising a set of control modules, wherein the control modules detect an object within detection areas along a pathway and communicate locations of the detected object along the pathway to other control modules within the set of control modules and wherein at least one of the control modules predicts a direction of the object along the pathway based on the locations and controls the lighting along a pathway based on the predicated direction of the object.

8. The light management system of claim 7, wherein the control modules comprise:
a) a sensor for detecting the motion or occupancy;
b) a control circuit for controlling a load circuit electrically coupled to the lighting;
c) a micro-processor with software configured to instruct the control circuit to control the load circuit when the locations of the control modules within the set of control modules correspond to the predicted direction of the object along the pathway; and
d) a transducer for receiving and transmitting detection signals from and to other control modules within the set of control modules that is used to calculate the predicted direction of the object along the pathway.

9. The light management system of claim 8, wherein the control modules include a coupling mechanism for attaching street light fixture.

10. The light management system of claim 8, wherein the control modules include an ambient light sensor configured to control the lighting based on a detected level of ambient.

11. The light management system of claim 8, wherein the control modules include a memory unit for storing light usage data.

12. The light management system of claim 8, wherein the control modules are commissioned with location addresses broadcast the location addresses and operating status to remote computer device.

13. A method of managing lighting comprising:
a) determining locations of an object along a pathway;
b) predicting a direction along the pathway based on the determined locations of the object; and
c) turning on lighting for a period of time along the predicted direction of the pathway.

14. The method of claim 13, further comprising determining a speed of the object along the pathway and turning on the lighting in the direction along the pathway at a rate that corresponds to or exceeds the determined speed of the object along the pathway.

15. The method of claim 13, wherein determining the locations of the object along the pathway utilizes control modules that are electrically coupled to the lighting and configured to control the lighting along the pathway.

16. The method of claim 15, wherein each of the modules comprises:
a) a motion or occupancy sensor for determining the locations of the object along the pathway;
b) a control circuit for controlling a load circuit electrically coupled to the lighting along the pathway;
c) a micro-processor with software configured to instruct the control circuit to control the load circuit to turn on the lighting in the predicted direction along the pathway; and
d) a communication system for communicating operating instructions between the control modules.

17. The method of claim 16, wherein the communication system includes a radio transducer.

18. The method of claim 16, wherein the control modules further comprise an ambient light sensor configured control the lighting based on a detected level of ambient light along the pathway.

19. The method of claim 16, wherein the control modules further comprise a memory unit for storing light usage data.

20. The method of claim 16, wherein the control modules are configured to be commissioned with a location addresses with a remote computer device.
